(19) United States
(12) Patent Application Publication
(10) Pub. No.: US 2015/0159867 A1
(43) Pub. Date: Jun. 11, 2015

(54) System and Method for Assessing Combustor Health During Operation

(71) Applicant: General Electric Company, Schenectady, NY (US)

(72) Inventors: Romano Patrick, Marietta, GA (US); Matthew Francis Lemmon, Marietta, GA (US); Subrat Nanda, Houston, TX (US); Jonathan David White, Grand Bay, AL (US)

(73) Assignee: General Electric Company, Schenectady, NY (US)

(21) Appl. No.: 14/097,549

(22) Filed: Dec. 5, 2013

(51) Int. Cl. F23M 11/00; G01M 15/14; F23N 1/00

(52) U.S. Cl. CPC F23M 11/00; F23N 1/00; G01M 15/14; F23N 2025/04; F23N 2041/20

(57) ABSTRACT

A system for assessing combustor health during operation of the combustor includes a combustor, a sensor configured to sense combustion dynamics pressure data from the combustor, and a computing device that is in communication with the sensor and configured to receive the combustion dynamics pressure data from the sensor. The computing device is programed to extract a feature from the combustion dynamics pressure data and generate feature values for the feature over a period of time. The computing device is also programmed to generate a cumulative form of the feature that is based on the feature values over a time series and to compare the cumulative form to a historical cumulative form.

### FIELD OF THE INVENTION

The present invention generally involves a combustor for a gas turbine. More specifically, the invention relates to a system and method for assessing combustor health during operation of the combustor.

### BACKGROUND OF THE INVENTION

A turbomachine, such as a gas turbine, generally includes an inlet section, a compressor section, a combustion section that includes a plurality of combustors, a turbine section and an exhaust section. The inlet section cleans and conditions a working fluid (e.g., air) and supplies the working fluid to the compressor section. The compressor section progressively compresses the working fluid and supplies a high pressure compressed working fluid to the combustors where it is mixed with a fuel and burned in a combustion chamber to generate combustion gases having a high temperature and pressure. The combustion gases flow along a hot gas path into the turbine section where they expand to produce work. For example, expansion of the combustion gases in the turbine section may rotate a shaft connected to a generator to produce electricity.

Each combustor includes various combustion hardware components. For example, a conventional gas turbine combustor may include one or more fuel nozzles, a combustion liner, a cooling flow sleeve, a transition duct, an impingement sleeve, a cap assembly and/or various mounting hardware such as brackets and radial compression or hula seals. Over time, various factors including thermal cycling, vibrations and/or pressure pulses within the combustor may result in combustion component degradation, thus resulting in a combustor that operates outside of an acceptable performance range or that fails entirely. As a result, regularly scheduled outages for inspection and repair must be executed, thus affecting machine availability.

Conventionally, outage schedules are at least partially based on component reliability history, component design criteria, operating environment and/or operational requirements such as operational hours/starts of the turbomachine. However, current methods/models for determining time between scheduled outages fall short of assessing, determining or estimating combustor health during operation of the combustor which may prevent unscheduled outages and/or extend the period between outages. Therefore, a system and method for assessing combustor condition during operation of the combustor would be useful.

### BRIEF DESCRIPTION OF THE INVENTION

Aspects and advantages of the invention are set forth below in the following description, or may be obvious from the description, or may be learned through practice of the invention.

One embodiment of the present invention is a system for assessing combustor health during operation of the combustor. The system includes a combustor, a sensor configured to sense combustion dynamics pressure data from the combustor, and a computing device that is in communication with the sensor and configured to receive the combustion dynamics pressure data from the sensor. The computing device is programed to extract a feature from the combustion dynamics pressure data and generate feature values for the feature over a period of time. The computing device is also programmed to generate a cumulative form of the feature that is based on the feature values over a time series and to compare the cumulative form to a historical cumulative form.

Another embodiment of the present invention is a method for assessing combustor health during combustor operation. The method includes receiving combustion dynamics pressure data from the combustor at a computing device from a sensor that is in communication with the combustor, extracting a feature from the combustion dynamics pressure data, generating a cumulative form of the feature that is based on feature values of the feature over a time series, and comparing the cumulative form to a historical cumulative form.

Another embodiment of the present invention is a method for assessing combustor health. The method includes providing or inputting a historical cumulative form from a first combustor into a computing device where the historical cumulative form relates to a historical feature from the first combustor. The method further includes generating a cumulative form of the same feature for a second combustor with respect to a time series via the computing device and comparing the cumulative form of the second combustor to the historical cumulative form of the first combustor via the computing device.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a functional block diagram of an exemplary gas turbine within the scope of the present disclosure;

FIG. 2 is a cross sectioned side view of an exemplary combustor as may incorporate various embodiments of the present disclosure;

FIG. 3 is a block diagram of a system for assessing combustor health according to one embodiment of the present invention;

FIG. 4 is a graphical illustration of exemplary combustion dynamics data measured as pressure with respect to time, according to the present disclosure;

FIG. 5 is a graphical illustration of an exemplary frequency spectrum generated from the combustion dynamics data as shown in FIG. 4, measured as amplitude with respect to frequency, according to the present disclosure;

FIG. 6 is a graphical illustration of an exemplary frequency spectrum as shown in FIG. 5, segmented into frequency intervals according to one embodiment of the present disclosure;

FIG. 7 is an illustration of exemplary tables or lists generated by a computing device representing feature values of features extracted from combustion dynamics data as shown in FIG. 6, according to one embodiment of the present disclosure;

FIG. 8 is a graphical illustration of a feature values and corresponding cumulative forms with respect to a time series according to one embodiment of the present disclosure;

FIG. 9 is a block-flow diagram of a method for assessing combustor health during operating of the combustor, according to one embodiment of the present disclosure; and

FIG. 10 is a block-flow diagram of a method for assessing combustor health during operating of the combustor, according to one embodiment of the present disclosure.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows. When introducing elements of aspects of the present disclosure or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Although exemplary embodiments of the present invention will be described generally in the context of an industrial/land based gas turbine for purposes of illustration, one of ordinary skill in the art will readily appreciate that embodiments of the present invention may be applied to any gas turbine such as an aircraft or marine gas turbine and are not limited to an industrial/land based gas turbine unless specifically recited in the claims.

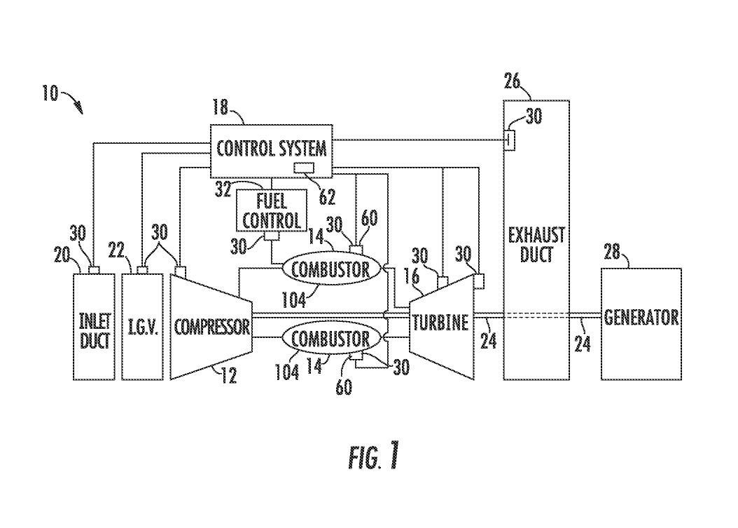

With regards to the figures, FIG. 1 is a schematic diagram of a gas turbine 10 including a compressor 12, a combustion system including one or more combustors 14, a turbine 16 drivingly coupled to the compressor 12 and a controller or control system 18. In one configuration, an inlet duct 20 channels ambient air across one or more inlet guide vanes 22 and into the compressor 12. The compressor 12 progressively compresses the ambient air and directs the compressed air to the combustors 14 where it is mixed with a fuel and burned to produce combustion gases. The combustion gases are routed through the turbine 16, thus causing rotation of a shaft 24. The combustion gases may then be routed from an outlet of the turbine 16 into an exhaust duct 26 that may include various emission control and/or sound absorbing devices and/or a heat recovery system. The turbine 16 may drive a generator 28 via the shaft 24 to produce electrical power or other mechanical work.

In particular configuration, various sensors 30 are electronically coupled to the control system 18. The sensors 30 may include flow sensors, speed sensors, flame detector sensors, valve position sensors, guide vane angle sensors, temperature sensors, acoustic sensors, pressure sensors and/or other sensors that sense various parameters relative to the operation of the combustor 14 and/or the gas turbine engine system 10. A fuel control system 32 regulates the fuel flowing from a fuel supply to the combustor(s) 14, and controls the fuel split between fuel circuits that allow for flow control of the fuel into various fuel nozzles within each combustor 14. The fuel control system 32 also may select the type of fuel for the combustor 14 and/or regulate the temperature of the fuel among other operations. The fuel control system 32 may be a separate unit or may be a component of the control system 18.

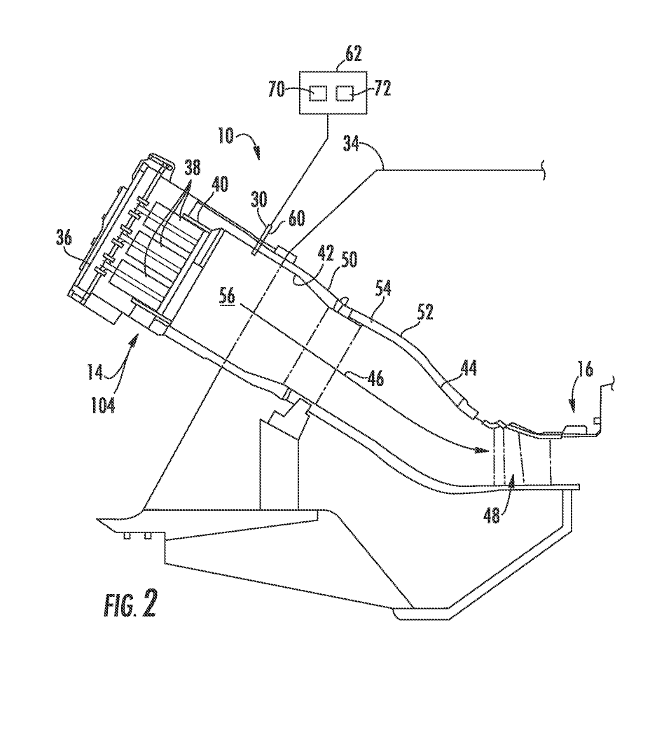

FIG. 2 provides a cross sectional side view of an exemplary combustor 14 as may incorporate various embodiments of the present invention. As shown, the combustor 14 is at least partially surrounded by a compressor discharge or outer casing 34. An end cover 36 is coupled to the outer casing 34. Various combustion hardware components are disposed within the outer casing. For example, the combustion hardware components generally include one or more fuel nozzles 38 extending generally axially downstream from the end cover 36 and partially through a fuel nozzle cap assembly 40. An annular liner such as a combustion liner 42 and/or a transition duct 44 extends downstream from the fuel nozzles 38 and/or the cap assembly 40 so as to define a hot gas path 46 for routing the hot combustion gases towards an inlet 48 to the turbine 16. An annular flow sleeve 50 may at least partially surround the combustion liner 42 and an annular impingement sleeve 52 may least partially surround the transition duct 44 so as to form an annular cooling flow passage 54 therebetween. A combustion chamber 56 is defined downstream from the fuel nozzles 38.

As the fuel and air mixture is burned in the combustors 14, various operating parameters such as fuel temperature, fuel type, fuel air splits, ambient air conditions, combustion hardware configuration, combustion hardware condition and operating mode or operating condition of the gas turbine generally affect the dynamic behavior of the combustor. In particular, combustion dynamic pressure pulsations or pressure waves may fluctuate or change within the combustors 14 as one or more of the operating parameters changes.

As used herein, the term “no-fault combustor” corresponds to a combustor that is operating within an acceptable performance range, for example, a combustor with no known damage to the combustion hardware components. In contrast, an “at-fault combustor” corresponds to a combustor that is operating outside of the acceptable performance range or that has failed entirely, for example due to a combustion hardware component failure. Overtime, various factors such as thermal stress and mechanical fatigue may degrade combustor performance and/or reliability which may eventually lead to an at-fault combustor. Thus, to achieve acceptable system durability and reliability, individual combustor and/or overall combustion system health should be carefully monitored, assessed and controlled. The present disclosure provides a system and method for detecting and/or assessing an at-fault combustor based on real time combustion dynamics data captured during operation of the combustor.

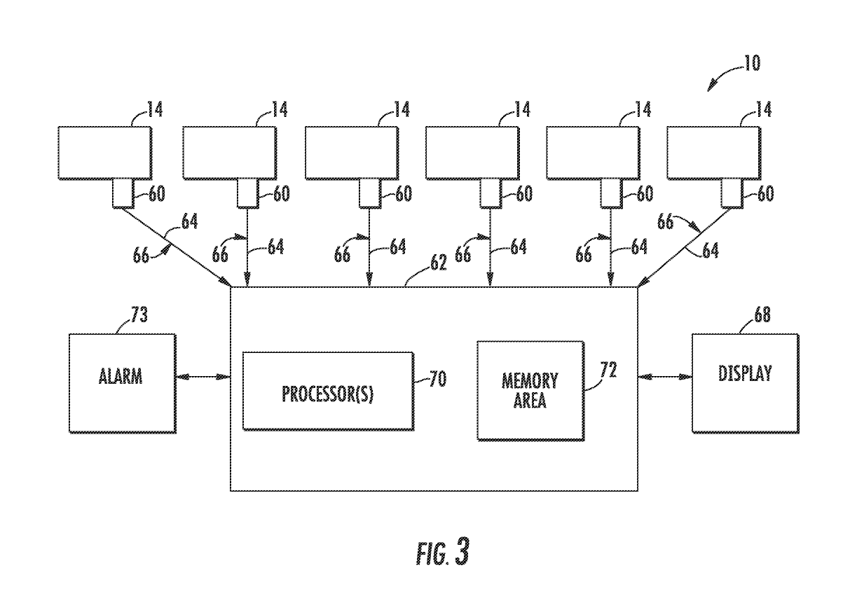

FIG. 3 is a block diagram illustrating a plurality of combustors 14 and a plurality of sensors 60 where each sensor 60 is coupled to a corresponding combustor 14 and each sensor 60 is in electronic communication with a computing device 62 according to one embodiment of the present invention. In particular embodiments, the combustors 14 may be configured the same or substantially similar to the exemplary combustor 14 as illustrated and described in FIG. 2. Although six combustors 14 and six sensors 60 are illustrated, one of ordinary skill in the art guided by the teachings herein will appreciate that embodiments are not limited to configurations with six combustors 14 and six sensors 60. Rather, embodiments may include any number of combustors 14 and/or sensors 60 that are in communication with the computing device 62.

The sensors 60 are configured to sense and/or measure static and/or dynamic pressure within the combustors 14. For example, the sensors 60 may comprise dynamic pressure sensors or dynamic pressure probes configured to sense or measure combustion dynamics pressure data 64 from the combustors 14. The sensors 60 may be configured to transmit or communicate a signal 66 that is indicative of combustion dynamics pressure within the combustors to the computing device 62. For example, the sensors 60 may be coupled to a wireless device (not shown) that is in communication with the computing device 62 and/or may be wired to the computing device 62.

In particular embodiments, as shown in FIG. 3, the computing device 62 may include or may be coupled to a display 68, at least one processor 70, a memory or data storage portion 72 and an alarm 73. The display 68 may be, for example, a capacitive touch screen display that is integrated into the computing device 62 or that is external to the computing device 62. User input functionality may be provided in the display 68 which acts as a user input selection device.

As used herein, the term “computing device” includes one or more processors or processing units, system memory, and some form of computer readable media. By way of example and not limitation, the computer readable media may include computer storage media and communication media. Computer storage media may include volatile and nonvolatile, removable and non-removable media implemented in any method or technology for storage of information such as computer readable instructions, data structures, program modules or other data. Communication media typically embody computer readable instructions, data structures, program modules, or other data in a modulated data signal, such as a carrier wave or other transport mechanism, and may include any information delivery media. Combinations of any of the above are also included within the scope of computer readable media.

The computing device may operate in a networked environment using logical connections to one or more remote computers, such as a remote computer. Although described in connection with an exemplary computing system environment, embodiments of the present disclosure are operational with numerous other general purpose or special purpose computing system environments or configurations. The computing system environment is not intended to suggest any limitation as to the scope of use or functionality of any aspect of the present disclosure. Moreover, the computing system environment should not be interpreted as having any dependency or requirement relating to any one or combination of components illustrated in the exemplary operating environment.

Examples of well-known computing systems, environments, and/or configurations that may be suitable for use with aspects of the present disclosure include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the present disclosure may be described in the general context of computer-executable instructions or algorithms, such as program modules, executed by one or more computers or other devices. The algorithms may be organized into one or more computer-executable components or modules. Generally, program modules include, but are not limited to, routines, programs, objects, components, and data structures that perform particular tasks or implement particular abstract data types.

Aspects of the present disclosure may be implemented with any number and organization of such components or modules. For example, aspects of the present disclosure are not limited to the specific algorithms or the specific components or modules illustrated in the figures and described herein. Other embodiments of the present disclosure may include different algorithms or components having more or less functionality than illustrated and described herein.

Aspects of the present disclosure may also be practiced in distributed computing environments where tasks are performed by remote processing devices that are linked through a communications network. In a distributed computing environment, program modules may be located in both local and remote computer storage media including memory storage devices. Aspects of the present disclosure may transform a general-purpose computer into a special-purpose computing device when configured to execute the instructions described herein.

The order of execution or performance of the operations in embodiments of the present disclosure illustrated and described herein is not essential, unless otherwise specified. That is, the operations may be performed in any order, unless otherwise specified, and embodiments of the present disclosure may include additional or fewer operations than those disclosed herein. For example, it is contemplated that executing or performing a particular operation before, contemporaneously with, or after another operation is within the scope of aspects of the present disclosure.

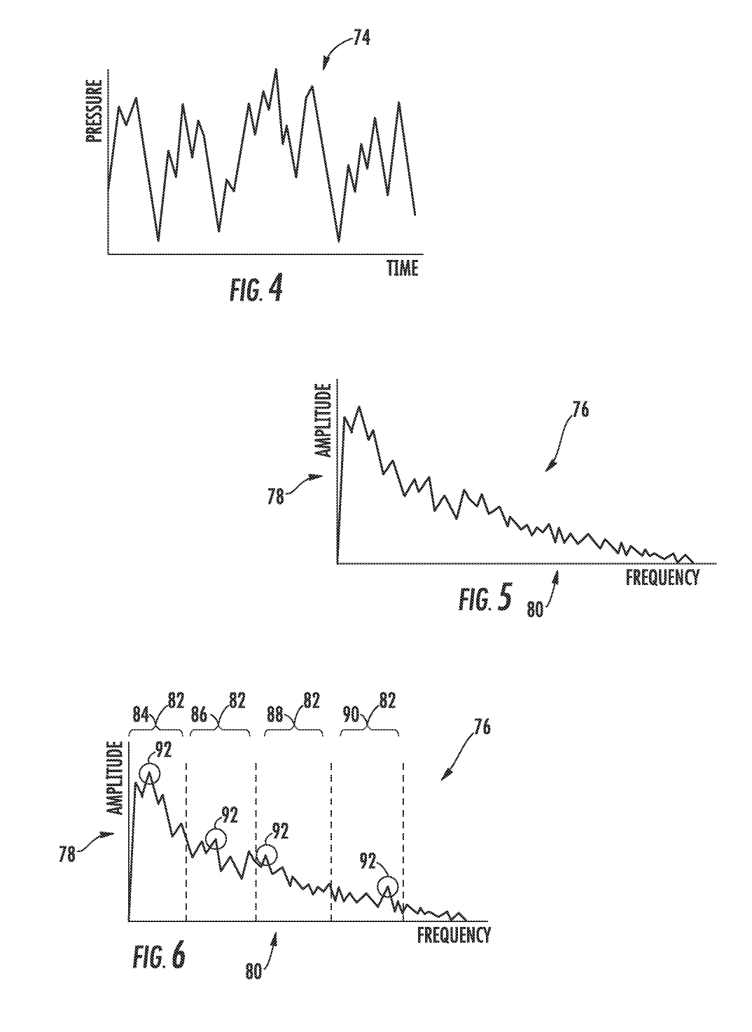

In one embodiment, the computing device 62 is configured to receive the signals 66 comprising the combustion dynamics pressure data 64 from the sensors 60. For example, the computing device 62 may communicate with the sensors 60 via wired and/or a wireless connections. As graphically illustrated in FIG. 4, the combustion dynamics pressure data 64 is generally received at the computing device 62 as pressure values 74. The computing device 62 may be programmed to track the pressure values 74 from the combustors 14 with respect to time.

In one embodiment, the computing device 62 is programmed to extract a feature that is common to each combustor 14 from the combustion dynamics pressure data and generate feature values for the feature during operation of the combustors 14. In particular embodiments, a feature represents or corresponds to the mechanical behavior and/or condition of one or more of the combustion hardware components. The mechanical behavior and/or condition may influence or impact the combustion dynamics pressure data during operation of the combustors 14.

In one embodiment, the feature is extracted from the combustion dynamics pressure data 64 via a known data conversion algorithm that is executed by the computing device 62. Specifically, as graphically illustrated in FIG. 5, the computing device 62 is programmed to convert the combustion dynamics pressure data 64 or pressure values 74 into a frequency spectrum 76 including amplitude 78 with respect to frequency 80 for each combustor 14.

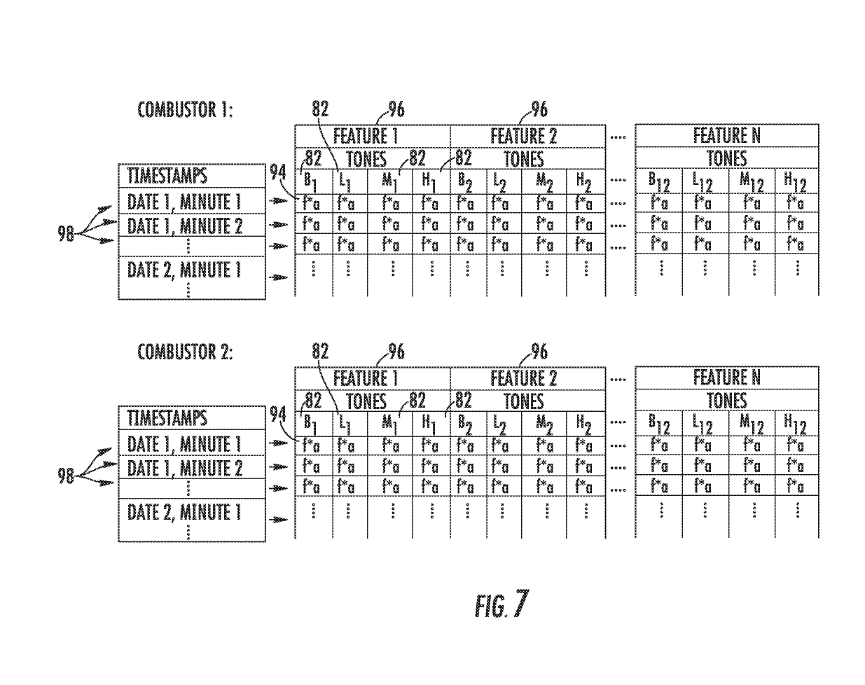

In one embodiment, as graphically illustrated in FIG. 6, the computing device 62 may be programmed to segment the frequency spectrum 76 into frequency intervals or “buckets” which correlate to certain performance and/or dynamic behaviors of the combustor 14 and/or the gas turbine 10. As should be obvious to one of ordinary skill in the art, this may be accomplished via any known algorithm for segmenting data points that is executable by the computing device 62.

As graphically illustrated in FIG. 6, the frequency intervals 82 may be segmented based on various acoustic modes or tones. For example, in one embodiment, the frequency intervals 82 may be segmented as blowout tone 84, low tone 86, medium tone 88 and high tone 90. By way of example, the blowout tone 84 may correspond to a frequency interval range between about zero hertz and about fifty hertz, the low tone 86 may correspond to a frequency range between about fifty hertz and about one hundred hertz, the medium tone 88 may correspond to a frequency range between about one hundred hertz and about five hundred hertz, and the high tone 90 may correspond to a frequency range greater than about five hundred hertz.

Due to high sampling rates that are potentially in the tens of kHz, the combustion dynamics pressure data 64 may include tens of thousands of samples per second. As a result, large amounts of combustion dynamics pressure data points are generated, thus requiring large amounts of computing power to process. As a result, the computing device 62 may be programmed to execute a computer algorithm such as a “maximum peak picking” or “down sampling” operation in order to reduce the number of frequency data points across the frequency spectrum 76.

The maximum peak picking operation identifies a peak pair which corresponds to peak amplitude at a specific frequency value within a particular frequency interval 82 for each combustor 14. The maximum peak picking algorithm may generate a timestamp for the peak pairs 92. In particular embodiments, there may be one peak pair 92 per each frequency interval 82. In other embodiments, there may be multiple peak pairs 92 per frequency interval 82.

In particular embodiments, the computing device 62 is programed to extract the feature or a plurality of features from the frequency spectrums from each combustor 14. For example, the computing device 62 may be programmed to execute a feature extraction algorithm. The feature extraction algorithm may extract a feature by performing various operations on one or more peak pairs 92 (amplitude+frequency) within a corresponding frequency interval 82. For example, the operation performed on a peak pair 92 may include measuring a moving average over time or normalizing a trend. In addition or in the alternative, the feature may be generated by combining the peak pair(s) 92 across the frequency intervals 82.

The feature may comprise, for example but not by limitation, a mathematical transformation or a statistical calculation of the peak pair 92. In one embodiment, the feature is generally based on the physics of the combustors 14 which may have a direct or indirect effect on the combustion dynamics pressure data 64 collected from the combustor 14. For example, the feature may be related to combustion hardware configuration, combustion hardware components, combustor type, vibration intensities, orientation of the combustors 14 on the gas turbine 10 or the number of combustors 14 on the gas turbine 10.

In addition or in the alternative, the feature may be based, at least in part, on statistical data which corresponds to various operational parameters of the combustor 14 and/or the gas turbine 10, taken in real-time or provided as historical data including but not limited to exhaust gas temperature, combustion valve settings, gas turbine load or operating condition, combustor firing temperature, fuel temperature, fuel split and fuel type. The statistical feature may be based on statistical averages, trends, outliers or the like. The statistical feature or features may provide data that may be related to generic differences between operational profiles of no-fault and at-fault combustors 14.

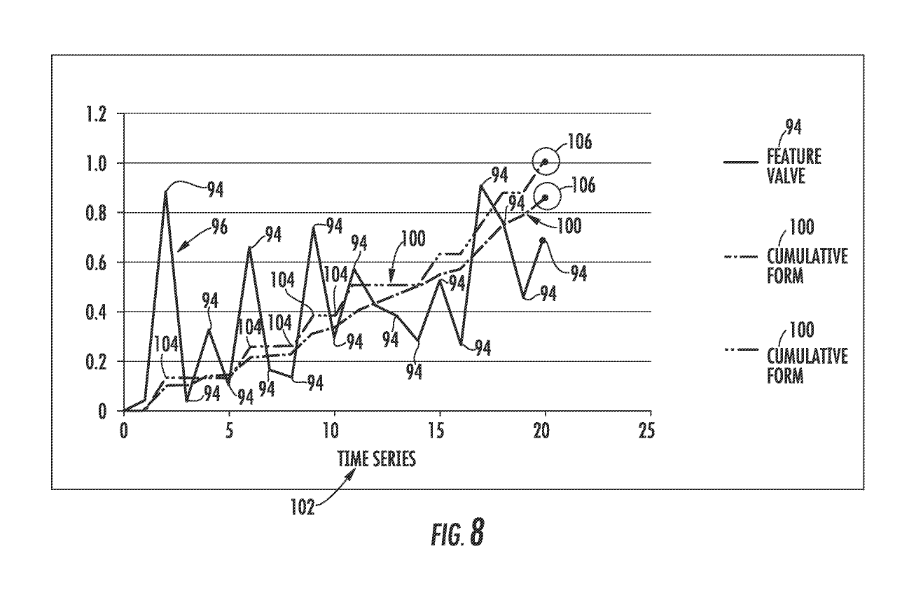

As graphically illustrated in FIG. 7, the computing device 62 is programmed to generate feature values 94 for one or more extracted features 96 within a corresponding frequency interval 82 over a period of time for each combustor 14. The feature values 94 may be the product of the amplitude and frequency of the peak pair(s) 92 or may be the sum of the amplitude and frequency of the peak pair(s) 92, or may be any other value extracted from the peak pair(s) 92. The computing device 62 may be programmed to provide a time stamp 98 for each feature value 94 generated or calculated.

The feature or feature values 94 may maintain several important relationships with the peak pair(s) 92. For example, the feature values 94 may correspond to an individual combustor 14, they may correspond to a specific frequency interval 82 and/or the feature values 94 may correspond to a time stamp 98 and/or a turbine operating condition or mode. As a result, the computing device 62 may be programmed to create lists, tables or matrices which track behavior of the feature 96 and/or the feature values 94 over time. In particular embodiments, the computing device 62 may be programed to generate and track feature values 94 for multiple features 96 for each combustor 14 over time.

In one embodiment, feature values 94 for a particular feature 96 are collected from one or more of the combustors 14 that have failed and/or began operating in an at-fault condition due to faults induced by progressive damage to one or more of the combustion hardware components such as thermal/mechanical fatigue, cracking, creep or fretting of one or more of the combustion hardware components. In addition, feature values 94 for the same feature 96 are collected from one or more of the combustors 14 that were operating simultaneously in a no-fault condition on a common gas turbine and at the moment when the at-fault combustors failed and/or began operating in the at-fault condition.

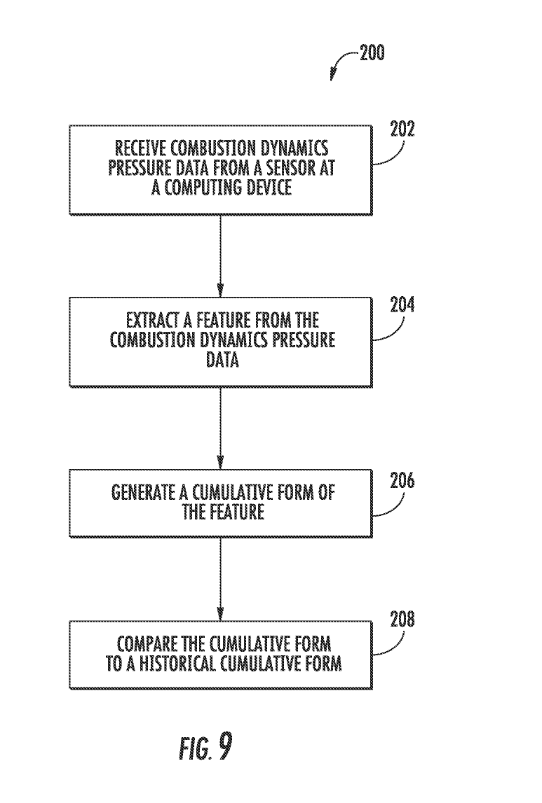

In one embodiment, as graphically illustrated in FIG. 8, a cumulative form 100 of each feature 96 for each combustor 14 is calculated based on the corresponding feature values 94. The cumulative form 100 may be calculated by programming the computing device 62 to execute an algorithm to perform a cumulative operation on the feature values 94 for each combustor 14 over a time series 102 or defined time period. The time series 102 should begin when there is no damage present in the combustors 14 and should end when at least one of the combustors 14 fails and/or enters an at-fault operating condition. In particular embodiments, the cumulative operation may include summing all of the feature values 94 within the time series 102. In other embodiments, the cumulative operation may include rainflow-counting, sum of squares or any known mathematical cumulative operation performed on the feature values 94.

In various embodiments, the cumulative form 100 for the feature 96 monotonically increases as the time series 102 progresses. For example, at each time instant within the time series 102 where there exists a feature value 94, a cumulative form value 104 for the feature 96 also exists. Although the feature value 94 may be greater than, equal to or less than a preceding feature value 94 in the time series 102, the cumulative form value 104 can only be greater or equal to the preceding cumulative form value 104. In other words, the cumulative form 100 never decreases as the feature values 94 change over the time series 102.

In particular embodiments, the cumulative form 100 corresponds to accumulating or progressive thermal and/or mechanical damage in a mechanical part such as one or more of the combustion hardware components. Specifically, the accumulation of damage in the combustion liner 42, the impingement sleeve 52, the flow sleeve 52, the fuel nozzles 38 and/or other combustion hardware components can change, but the amount of damage can never decrease, thus corresponding to the monotonic nature of the cumulative form 100.

In particular embodiments, the cumulative operation may take into account the operating conditions and/or modes of the gas turbine. For example, certain operating conditions or modes, such as fuel temperature, fuel type, turbine load or the like may result in variations in combustion dynamics of combustors during operation which may cause the cumulative form 100 to increase more quickly for each cumulative value 104 of the cumulative form 100, thus corresponding to an increased reduction in remaining life expectancy for the corresponding combustion hardware components and/or the combustors 14. In other words, the operating condition and/or mode of the gas turbine may scale the individual feature values 94. For example, the output power of the turbine 16 may be used to scale the feature values 94. However, the effect of the operating conditions and/or modes cannot be such that the cumulative form 100 of the feature 96 decreases at any point in time.

In one embodiment, the computing device 62 is programmed to generate a cumulative form ending value 106 for each cumulative form 100 for each combustor 14. The cumulative form ending values 106 represent a moment in the time series 102 at which one or more of the combustors failed and/or began operating in an at-fault condition. In one embodiment, the computing device 62 is programmed to compare the cumulative form ending values 106 for the combustors 14 that have failed and/or began operating in an at-fault condition against the cumulative form ending values 106 for the no-fault combustors 14.

In certain instances, the combustors 14 that failed and/or began operating in an at-fault condition have corresponding cumulative form ending values 106 that are higher or greater in magnitude for a given feature 96 than the cumulative form ending values 106 for the same feature 96 in the combustors 14 that were operating in a no-fault condition. Where the feature 96 or features correspond to one or more combustion hardware components, such as the combustion liner 42, the transition duct 44, the flow sleeve 50, the impingement sleeve 52 or the fuel nozzles 38, a higher cumulative form ending value 106 may be indicative of thermal and/or mechanical failure of one or more of the combustion hardware components, thus identifying that feature 96 as a viable candidate for creating a risk metric. In one embodiment, the cumulative form can be further post-processed to generate a risk metric, which is a quantity that approximates the likely hood or probability that a combustor will fail in the near term.

In one embodiment, the cumulative form ending values 106 of the combustor 14 or combustors that failed and/or that began operating in an at-fault condition and the cumulative form ending values 106 for the same feature 96 in the combustor 14 or combustors that were operating simultaneously in a no-fault condition may be used as baseline or historical cumulative form ending values to generate historical cumulative forms for detecting or predicting combustor failure during operation of the gas turbine 10. In one embodiment, the historical cumulative forms, the historical cumulative form values and/or the historical cumulative form ending values may be compared to a cumulative form 100, a cumulative form value 104 and/or a cumulative form ending value 106 of a combustor 14 or combustors that are in service to assess the health of the combustor in service.

In one embodiment, a risk metric is generated by programming the computing device 62 to execute a mathematical function that is based on the historical cumulative form ending values for the failed or at-fault combustors and the historical cumulative form ending values for the no-fault combustors. An exemplary mathematical function or equation is:

$$R = \frac{C - H}{F - H}$$

wherein R represents a risk value, C represents a cumulative form value for a particular feature of a combustor that is in currently in service, H represents an average cumulative form ending value based on the historical cumulative form ending values for the same feature for the no-fault combustors, and F represents an average cumulative form ending value based on the historical cumulative form ending values for the same feature for the failed or at-fault combustors. The risk value R provides a numerical value that is representative of the condition or accumulated damage of one or more combustion hardware components or the condition of the combustor while it is in service. Over time, as more historical cumulative form ending values are collected for failed or at-fault and no-fault combustors, the risk metric may be updated to improve the accuracy of the risk metric.

Selection of adequate or desirable cumulative forms of the features for the risk metrics may be accomplished by comparing the cumulative form values and/or historical cumulative form ending values against the cumulative form values and/or historical cumulative form ending values of failed combustors. For example, cumulative forms of features or risk metrics that show or reflect a tendency to exhibit large cumulative form values for the failed combustors and lower values for the healthy combustors would be desirable. To support the selection or comparison activities one may utilize statistics, correlation analysis, a receiver operating characteristic curve, detectability analysis or the like. In addition or in the alternative, supervised machine learning algorithms may be used to assess the effectiveness of the cumulative forms of features or of the risk metrics at predicting the failure condition of a combustor.

In one embodiment, the risk metric is used to determine appropriate thresholds to trigger inspection, testing and/or maintenance scheduling to reduce the risk of unexpected sudden failure or turbine outages. In one embodiment, the computing device 62 is programmed to generate an alarm once the risk value R reaches a trigger value. For example, it may be determined from the historical cumulative feature ending values that a risk value R of 0.5 to 1.0 should trigger inspection of the particular combustion hardware component associated with the particular feature, and that a risk value R of greater than 1.0 should trigger replacement of the particular combustion hardware component associated with the particular feature.

The cumulative form value and/or the of a cumulative form ending value and a comparison against the historical cumulative form ending value or the cumulative form value, or a risk metric, can be used to make operational decisions regarding the gas turbine 10 while in service or in operation. For example degradation or damage accumulation of the combustor 14 can be approximated by these values before the combustor 14 fails. By tracking and assessing the approximated degradation or accumulated damage provided by or reflected in the risk value and/or the cumulative form values, operators can in turn modify inspection, maintenance, or control schedules of the gas turbine to minimize the likelihood or probability that a combustor fails suddenly or unexpectedly. Thus reducing the potential for costly unscheduled outages or repairs.

The various embodiments and described and illustrated herein provide a method 200 for assessing combustor health during operation of the combustor 14, as illustrated in FIG. 9. At step 202, the method 200 includes receiving the combustion dynamics pressure data 64 from a first combustor 14 at the computing device 62 from the sensor 60. At step 204, the method 200 includes extracting a feature 96 from the combustion dynamics pressure data 64. At step 206, the method 200 includes generating a cumulative form 100 of the feature 96 over a time series 102 that is based on the feature values 94. At step 208, the method 200 includes comparing the cumulative form 100 to a historical cumulative form. In particular embodiments, the cumulative form 100 of the feature 96 is monotonically increasing. In one embodiment, the historical cumulative form is generated from historical feature values that correspond to an at-fault combustor. In one embodiment, the historical cumulative form is generated using historical feature values from a second combustor and the historical feature values are indicative of progressive damage to one or more hardware components of the second combustor.

In one embodiment, the method 200 further includes generating a cumulative form ending value 106. In one embodiment, the method 200 includes comparing the cumulative form ending value 106 to a historical cumulative form ending value. In one embodiment, the method 200 includes calculating a risk value R based on the comparison between the cumulative form ending value 106 and the historical cumulative form ending value.

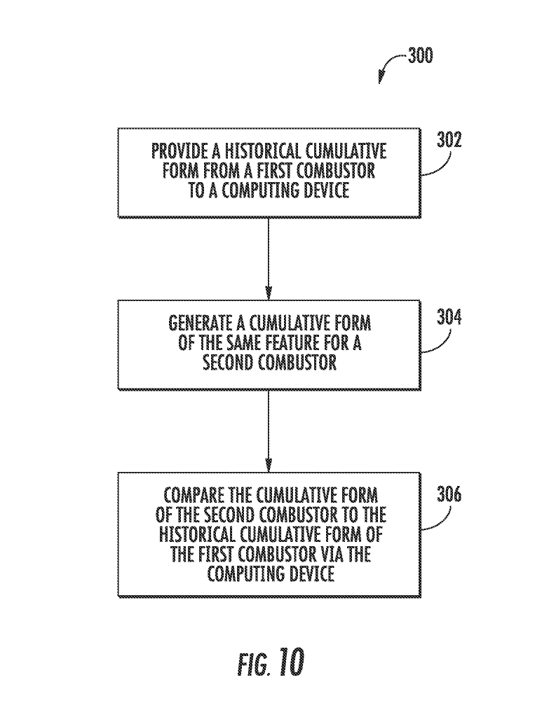

The various embodiments as described and illustrated herein provide a method 300 for assessing combustor health during operation of the combustor 14. As illustrated in FIG. 10, at step 302, the method 300 includes providing or inputting a historical cumulative form from a first combustor 14 into the computing device 62 where the historical cumulative form relates to a historical feature from the first combustor 14. At step 304, the method 300 includes generating a cumulative form 100 of the same feature 96 for a second combustor 14 with respect to a time series 102 via the computing device 62. At step 306, the method 300 includes comparing the cumulative form 100 of the second combustor 14 to the historical cumulative form of the first combustor 14 via the computing device 62.

In one embodiment, the cumulative form 100 of the feature 96 is monotonically increasing. In another embodiment, the historical cumulative form is generated from historical feature values that correspond to an at-fault combustor. In one embodiment, the historical cumulative form is generated using historical feature values that are indicative of progressive damage to one or more combustion hardware components of the first combustor.

In one embodiment, the method 300 further includes generating a cumulative form ending value 106 and comparing the cumulative form ending value 106 to a historical cumulative form ending value. In another embodiment, the method 300 further includes calculating a risk value R based on the comparison between the cumulative form ending value 106 and the historical cumulative form ending value.

The various embodiments provided herein, provide various technical advantages or benefits over existing systems and methods for assessing combustor health between scheduled and/or unscheduled outages. For example, the ability to assess combustor health in real time increases overall reliability of the gas turbine. In addition, the real time combustor health information allows operators to increase the operating time between scheduled outages, thereby resulting in a more efficient use of the gas turbine and potentially increasing revenue and/or gas turbine availability. Another benefit may be that the combustor health information provides an operator with data that indicates the effects on combustor hardware component life based at least in part on the operating mode or condition of the gas turbine. In addition, the system and methods presented herein provide an operator with a risk assessment of individual combustion hardware components in real time.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A system for assessing combustor health during operation of the combustor, comprising:
a combustor;
a sensor configured to sense combustion dynamics pressure data from the combustor; and
a computing device in communication with the sensor and configured to receive the combustion dynamics pressure data from the sensor, the computing device programed to:
extract a feature from the combustion dynamics pressure data and generate feature values for the feature over a period of time;
generate a cumulative form of the feature that is based on the feature values over a time series; and
compare the cumulative form to a historical cumulative form.

2. The system as in claim 1, wherein the cumulative form is monotonically increasing.

3. The system as in claim 1, wherein the historical cumulative form is generated from historical feature values that correspond to an at-fault combustor.

4. The system as in claim 1, wherein the computing device is programmed to generate an cumulative form ending value.

5. The system as in claim 4, wherein the computing device is programed to compare the cumulative form ending value to a historical cumulative form ending value.

6. The system as in claim 5, wherein the computing device is programmed to calculate a risk value based on the comparison between the cumulative form ending value and the historical cumulative form ending value.

7. The system as in claim 6, wherein the computing device is programmed to generate an alarm once the risk value reaches a trigger value.

8. A method for assessing combustor health during combustor operation, comprising;
receiving combustion dynamics pressure data from the combustor at a computing device from a sensor in communication with the combustor;
extracting a feature from the combustion dynamics pressure data;
generating a cumulative form of the feature that is based on feature values of the feature over a time series; and
comparing the cumulative form to a historical cumulative form.

9. The method as in claim 8, wherein the cumulative form of the feature is monotonically increasing.

10. The method as in claim 8, wherein the historical cumulative form is generated from historical feature values that correspond to an at-fault combustor.

11. The method as in claim 8, further comprising generating an cumulative form ending value.

12. The method as in claim 8, wherein the historical cumulative form is generated using historical feature values from a second combustor, wherein the historical feature values are indicative of progressive damage to one or more hardware components of the second combustor.

13. The method as in claim 11, further comprising comparing the cumulative form ending value to a historical cumulative form ending value.

14. The method as in claim 13, further comprising calculating a risk value based on the comparison between the cumulative form ending value and the historical cumulative form ending value.

15. A method for assessing combustor health, comprising;
providing a historical cumulative form from a first combustor to a computing device, wherein the historical cumulative form relates to a historical feature from the first combustor;
generating a cumulative form of the same feature for a second combustor with respect to a time series via the computing device; and
comparing the cumulative form of the second combustor to the historical cumulative form of the first combustor via the computing device.

16. The method as in claim 15, wherein the cumulative form of the feature is monotonically increasing.

17. The method as in claim 15, wherein the historical cumulative form is generated from historical feature values that correspond to an at-fault combustor.

18. The method as in claim 15, wherein the historical cumulative form is indicative of progressive damage to one or more combustion hardware components of the first combustor.

19. The method as in claim 15, further comprising generating an cumulative form ending value and comparing the cumulative form ending value to a historical cumulative form ending value.

20. The method as in claim 19, further comprising calculating a risk value based on the comparison between the cumulative form ending value and the historical cumulative form ending value.
